(19) United States
(12) Patent Application Publication
(10) Pub. No.: US 2026/0116724 A1
(43) Pub. Date: Apr. 30, 2026

(54) LIFT DEVICE

(71) Applicant: Oshkosh Corporation, Oshkosh, WI (US)

(72) Inventors: Devin Rosencrance, Oshkosh, WI (US); Patrick Dingman, Oshkosh, WI (US); Luke Dugan, Oshkosh, WI (US)

(73) Assignee: Oshkosh Corporation, Oshkosh, WI (US)

(21) Appl. No.: 19/086,240

(22) Filed: Mar. 21, 2025

Related U.S. Application Data
(60) Provisional application No. 63/712,679, filed on Oct. 28, 2024.
(60) Provisional application No. 63/712,656, filed on Oct. 28, 2024.

(51) Int. Cl. B66F 11/04

(52) U.S. Cl. CPC B66F 11/04

(57) ABSTRACT

A lift device includes a chassis, a work platform configured to support an operator, and a lift assembly having a first end portion coupled to the chassis and a second end portion coupled to the work platform. The lift assembly includes a first band and a second band each including a deployed portion and a stored portion where the deployed portion of the first band engaging the deployed portion of the second band to form a support column at least partially supporting the work platform, at least one storage area containing the stored portion of the first band and the stored portion of the second band, and an actuator configured to drive the stored portion of the first band and the second band to exit the at least one storage area and increase a length of the support column such that the support column raises the work platform.

### CROSS-REFERENCE TO RELATED PATENT APPLICATIONS

This application claims the benefit of and priority to U.S. Provisional Application No. 63/712,679, filed on Oct. 28, 2024, and U.S. Provisional Application No. 63/712,656, filed on Oct. 28, 2024, the entire disclosures of which are hereby incorporated by reference herein.

### BACKGROUND

The present disclosure relates generally to vehicles or work machines. More specifically, the present disclosure relates to lift devices.

Lift devices, such as scissor lifts, are used in construction and maintenance operations to lift personnel, equipment, and materials to elevated heights. Scissor lifts utilize a series of linked supports to support a work platform at such elevated heights. When elevated, scissor lifts may experience swaying of the work platform (e.g., due to wind, due to movement of the lift device, due to movement of personnel on the work platform, etc.), which an operator supported by the platform may find undesirable.

### SUMMARY

One embodiment relates to a lift device. The lift device includes a chassis, a work platform configured to support an operator, and a lift assembly having a first end portion coupled to the chassis and a second end portion coupled to the work platform. The lift assembly includes a first band and a second band each including a deployed portion and a stored portion where the deployed portion of the first band engaging the deployed portion of the second band to form a support column at least partially supporting the work platform, at least one storage area containing the stored portion of the first band and the stored portion of the second band, and an actuator configured to drive the stored portion of the first band and the stored portion of the second band to exit the at least one storage area and increase a length of the support column such that the support column raises the work platform.

Another embodiment relates to an aerial work platform. The aerial work platform includes a chassis, a work platform, and a scissor-less and boom-less lift assembly extending between the chassis and a bottom of the work platform. The scissor-less and boom-less lift assembly is configured to vertically raise and lower the work platform relative to the chassis.

Still another embodiment relates to a lift device. The lift device includes a chassis, a work platform, a lift assembly extending between the chassis and a bottom of the work platform, and a rotation control assembly coupled to the chassis and the work platform. The lift assembly is rotatably coupled to the work platform. The lift assembly is configured to vertically raise and lower the work platform relative to the chassis. The rotation control assembly is configured to limit rotation of the work platform relative to the chassis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a scissor lift, according to an exemplary embodiment.

FIG. 2 is a block diagram of a control system for the scissor lift of FIG. 1, according to an exemplary embodiment.

FIG. 3 is a front view of the scissor lift of FIG. 1 in a raised configuration.

FIG. 4 is a front view of the scissor lift of FIG. 1 in the raised configuration and responding to a laterfal force.

FIG. 5 is a front view of the scissor lift of FIG. 1 in the raised configuration with a stability system, according to an exemplary embodiment.

FIG. 6 is a front view of the scissor lift and the stability system of FIG. 5 in a lowered configuration.

FIG. 7 is a side view of a fixed cable coupler of the stability system of FIG. 5, according to an exemplary embodiment.

FIG. 8 is a side view of a variable cable coupler of the stability system of FIG. 5, according to an exemplary embodiment.

FIG. 9 is a side view of a pulley cable coupler of the stability system of FIG. 5, according to an exemplary embodiment.

FIG. 10 is a side view of a cable assembly of the stability system of FIG. 5, according to an exemplary embodiment.

FIG. 11 is a side view of a cable assembly of the stability system of FIG. 5, according to another exemplary embodiment.

FIG. 12 is a perspective view of the scissor lift of FIG. 1 with the stability system of FIG. 5.

FIG. 13 is a perspective view of a lift device according to an exemplary embodiment.

FIG. 14 is a side view of a lift actuator of the lift device of FIG. 13, according to an exemplary embodiment.

FIGS. 15 and 16 are partial section views of the lift actuator of FIG. 14.

FIG. 17 is a front view of a first band of the lift actuator of FIG. 14, according to an exemplary embodiment.

FIG. 18 is a top view of a second band of the lift actuator of FIG. 14, according to an exemplary embodiment.

FIG. 19 is a section view of the lift actuator of FIG. 14 showing the first band of FIG. 17 engaging the second band of FIG. 18.

FIG. 20 is a perspective view of a lift device according to another exemplary embodiment.

FIG. 21 is a perspective view of a lift device according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a lift device includes a scissor lift assembly that connects a work platform to a chassis. The scissor lift assembly is configured to raise and lower the work platform relative to the chassis. At elevated positions, external forces on the work platform may cause the work platform to sway, which undesirably impacts the experience of an operator positioned on the work platform.

To counteract this swaying, the lift device includes a stability system including a series of stability cable assemblies. Each stability cable assembly includes two or more interface assemblies coupled to the chassis and the work platform and a stability cable that has a working length extending between the interface assemblies. When the lift assembly raises the work platform, the interface assemblies increase the working length to permit the lift assembly to extend. When the lift assembly lowers the work platform, the interface assemblies decrease the working length to maintain a constant or substantially constant tension on the stability cables and to prevent the stability cables from going slack. When the lift assembly is holding position, the interface assemblies fix the working length of the stability cable. Accordingly, if an external force acts to cause swaying of the work platform, the stability cables apply a tensile force to resist the swaying and hold the work platform stationary or substantially stationary.

The figures further illustrate a lift device including a lift actuator that supports a work platform without the use of a scissor lift assembly. The lift actuator includes a first band and a second band that are selectively dispensed from a pair of storage areas to engage one another and form a support column. The bands may be transferred between the storage areas and the support column by an electric motor to raise and lower the work platform. The lift device may utilize a stability system including a series of stability cable assemblies to resist (e.g., prevent) rotation of the work platform.

### Scissor Lift

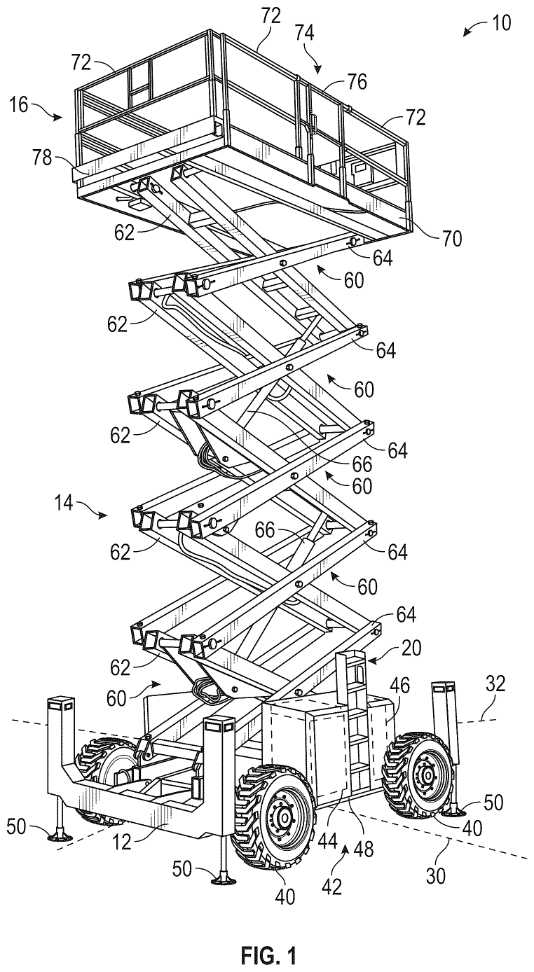

According to the exemplary embodiment shown in FIG. 1, a lift device (e.g., a vertical lift, a scissor lift, an aerial work platform, a boom lift, a telehandler, etc.), shown as scissor lift 10, includes a chassis, shown as frame assembly 12. A lift assembly (e.g., a scissor lift assembly, a boom assembly, etc.), shown as lift assembly 14, couples the frame assembly 12 to a work platform or operator platform, shown as platform 16. The frame assembly 12 supports the lift assembly 14 and the platform 16, both of which are disposed directly above the frame assembly 12. In use, the lift assembly 14 extends and retracts to raise and lower the platform 16 relative to the frame assembly 12 between a lowered position and a raised position. The scissor lift 10 includes an access assembly (e.g., a ladder assembly, a stair assembly, etc.), shown as access assembly 20, that is coupled to the frame assembly 12 and configured to facilitate access to the platform 16 from the ground by an operator when the platform 16 is in the lowered position.

Referring again to FIG. 1, the frame assembly 12 defines a horizontal plane having a lateral axis 30 and a longitudinal axis 32. In some embodiments, the frame assembly 12 is rectangular, defining lateral sides extending parallel to the lateral axis 30 and longitudinal sides extending parallel to the longitudinal axis 32. In some embodiments, the frame assembly 12 is longer in a longitudinal direction than in a lateral direction. In some embodiments, the scissor lift 10 is configured to be stationary or semi-permanent (e.g., a system that is installed in one location at a work site for the duration of a construction project). In such embodiments, the frame assembly 12 may be configured to rest directly on the ground and/or the scissor lift 10 may not provide powered movement across the ground. In other embodiments, the scissor lift 10 is configured to be moved frequently (e.g., to work on different tasks, to continue the same task in multiple locations, to travel across a job site, etc.). Such embodiments may include systems that provide powered movement across the ground.

Referring to FIG. 1, the scissor lift 10 is supported by a series of tractive assemblies 40, each including a tractive element (e.g., a tire, a wheel, a track, etc.), that are rotatably coupled to the frame assembly 12. The tractive assemblies 40 may be powered or unpowered. As shown in FIG. 1, the tractive assemblies 40 are configured to provide powered motion in the direction of the longitudinal axis 32. One or more of the tractive assemblies 40 may be pivotable (e.g., about a vertical axis) to steer the scissor lift 10. In some embodiments, the scissor lift 10 includes a powertrain system 42. In some embodiments, the powertrain system 42 includes a primary driver 44 (e.g., an engine, an electric motor, etc.). A transmission may receive the mechanical energy and provide an output to one or more of the tractive assemblies 40. In some embodiments, the powertrain system 42 includes a pump 46 configured to receive mechanical energy from the primary driver 44 and output a pressurized flow of hydraulic fluid. The pump 46 may supply mechanical energy (e.g., through a pressurized flow of hydraulic fluid) to individual motive drivers (e.g., hydraulic motors) configured to facilitate independently driving each of the tractive assemblies 40. In other embodiments, the powertrain system 42 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 40 include an individual motive driver (e.g., an electric motor that is electrically coupled to the energy storage device, etc.) configured to facilitate independently driving each of the tractive assemblies 40. The outside source of electrical energy may charge the energy storage device or power the motive drivers directly. The powertrain system 42 may additionally or alternatively provide mechanical energy (e.g., using the pump 46, by supplying electrical energy, etc.) to one or more actuators of the scissor lift 10 (e.g., the leveling actuators 50, the lift actuators 66, etc.). One or more components of the powertrain system 42 may be housed in an enclosure, shown as housing 48. The housing 48 is coupled to the frame assembly 12 and extends from a side of the scissor lift 10 (e.g., a left or right side). The housing 48 may include one or more doors to facilitate access to components of the powertrain system 42.

In some embodiments, the frame assembly 12 is coupled to one or more actuators, outriggers, or stabilizers, shown in FIG. 1 as leveling actuators 50. The scissor lift 10 includes four leveling actuators 50, one in each corner of the frame assembly 12. The leveling actuators 50 extend and retract vertically between a stored position and a deployed position. In the stored position, the leveling actuators 50 are raised and do not contact the ground. In the deployed position, the leveling actuators 50 contact the ground, lifting the frame assembly 12. The length of each of the leveling actuators 50 in their respective deployed positions may be varied to adjust the pitch (i.e., rotational position about the lateral axis 30) and the roll (i.e., rotational position about the longitudinal axis 32) of the frame assembly 12. Accordingly, the lengths of the leveling actuators 50 in their respective deployed positions may be adjusted such that the frame assembly 12 is leveled with respect to the direction of gravity, even on uneven or sloped terrains. The leveling actuators 50 may additionally lift the tractive elements of the tractive assemblies 40 off the ground, preventing inadvertent driving of the scissor lift 10.

Referring to FIG. 1, the lift assembly 14 includes a series of subassemblies, shown as scissor layers 60, each including a pair of first members, shown as inner members 62, and a pair of second members, shown as outer members 64. In each scissor layer 60, the inner members 62 are received between the corresponding pair of the outer members 64. The inner members 62 are pivotally coupled to the outer members 64 near the centers of both the inner members 62 and the outer members 64. Accordingly, inner members 62 pivot relative to the outer members 64 about a lateral axis. The scissor layers 60 are stacked atop one another to form the lift assembly 14. Each pair of inner members 62 and each pair of outer members 64 has a top end and a bottom end. The bottom ends of the inner members 62 are pivotally coupled to the top ends of the outer members 64 from the scissor layer 60 immediately below them, and the bottom ends of the outer members 64 are pivotally coupled to the top ends of the inner members 62 from the scissor layer 60 immediately below them. Accordingly, each of the scissor layers 60 are coupled to one another such that movement of one scissor layer 60 causes a corresponding similar movement in all of the other scissor layers 60. The bottom ends of the inner members 62 and the outer members 64 belonging to the lowermost of the scissor layers 60 are coupled to the frame assembly 12. The top ends of the inner members 62 and the outer members 64 belonging to the uppermost of the scissor layers 60 are coupled to the platform 16. The inner members 62 and/or the outer members 64 may be slidably coupled to the frame assembly 12 and the platform 16 to facilitate the movement of the lift assembly 14. Scissor layers 60 may be added to or removed from the lift assembly 14 to increase or decrease, respectively, the maximum height that the platform 16 is capable of reaching.

One or more actuators (e.g., hydraulic cylinders, pneumatic cylinders, motor-driven leadscrews, etc.), shown as lift actuators 66, are configured to extend and retract the lift assembly 14. As shown in FIG. 1, the lift assembly 14 includes a pair of lift actuators 66. As shown, the lift actuators 66 are pivotally coupled to an inner member 62 at one end and pivotally coupled to another inner member 62 at the opposite end. These inner members 62 belong to a first scissor layer 60 and a second scissor layer 60 that are separated by a third scissor layer 60. In other embodiments, the lift assembly 14 includes more or fewer lift actuators 66 and/or the lift actuators 66 are otherwise arranged. The lift actuators 66 are configured to actuate the lift assembly 14 to selectively reposition the platform 16 between the lowered position, where the platform 16 is proximate the frame assembly 12, and the raised position (e.g., shown in FIG. 1), where the platform 16 is at an elevated height. In some embodiments, extension of the lift actuators 66 moves the platform 16 vertically upward (extending the lift assembly 14), and retraction of the lift actuators 66 moves the platform 16 vertically downward (retracting the lift assembly 14). In other embodiments, extension of the lift actuators 66 retracts the lift assembly 14, and retraction of the lift actuators 66 extends the lift assembly 14. In some embodiments, the outer members 64 are approximately parallel and/or contacting one another when with the lift assembly 14 in a stored position. The scissor lift 10 may include various components to drive the lift actuators 66 (e.g., pumps, valves, compressors, motors, batteries, voltage regulators, etc.).

Referring still to FIG. 1, the platform 16 includes a support surface, shown as deck 70, defining a top surface configured to support operators and/or equipment and a bottom surface opposite the top surface. The bottom surface and/or the top surface extend in a substantially horizontal plane. A thickness of the deck 70 is defined between the top surface and the bottom surface. The bottom surface is coupled to a top end of the lift assembly 14. In some embodiments, the deck 70 is rectangular. In some embodiments, the deck 70 has a footprint that is substantially similar to that of the frame assembly 12.

Referring again to FIG. 1, a number of guards or railings, shown as guard rails 72, extend upwards from the deck 70. The guard rails 72 extend around an outer perimeter of the deck 70, partially or fully enclosing a supported area on the top surface of the deck 70 that is configured to support operators and/or equipment. The guard rails 72 provide a stable support for the operators to hold and facilitate containing the operators and equipment within the supported area. The guard rails 72 define one or more openings 74, through which the operators can access the deck 70. The opening 74 may be a space between two guard rails 72 along the perimeter of the deck 70, such that the guard rails 72 do not extend over the opening 74. Alternatively, the opening 74 may be defined in a guard rail 72 such that the guard rail 72 extends across the top of the opening 74. In some embodiments, the platform 16 includes a door 76 that selectively extends across the opening 74 to limit (e.g., prevent) movement through the opening 74. The door 76 may rotate (e.g., about a vertical axis, about a horizontal axis, etc.) or translate between a closed position, shown in FIG. 1, and an open position. In the closed position, the door 76 prevents movement through the opening 74. In the open position, the door 76 facilitates movement through the opening 74.

As shown in FIG. 1, the platform 16 further includes one or more platforms, shown as extendable decks 78, that are received by the deck 70 and that each define a top surface. The extendable decks 78 are selectively slidable relative to the deck 70 between an extended position and a retracted position. In the retracted position, shown in FIG. 1, the extendable decks 78 are completely or almost completely received by the deck 70. In the extended position, the extendable decks 78 project outward (e.g., longitudinally, laterally, etc.) relative to the deck 70 such that their top surfaces are exposed. With the extendable decks 78 projected, the top surfaces of the extendable decks 78 and the top surface of the deck 70 are all configured to support operators and/or equipment, expanding the supported area. In some embodiments, the extendable decks 78 include guard rails partially or fully enclose the supported area. The extendable decks 78 facilitate accessing areas that are spaced outward from the frame assembly 12.

Referring to FIG. 1, the access assembly 20 is coupled to a longitudinal side of the frame assembly 12. As shown in FIG. 1, the access assembly 20 is a ladder assembly extending along a longitudinal side of the frame assembly 12. The access assembly 20 is aligned with the door 76 such that, when the platform 16 is in the lowered position, the access assembly 20 facilitates access to the upper surface of the platform 16 through the opening 74.

### Control System

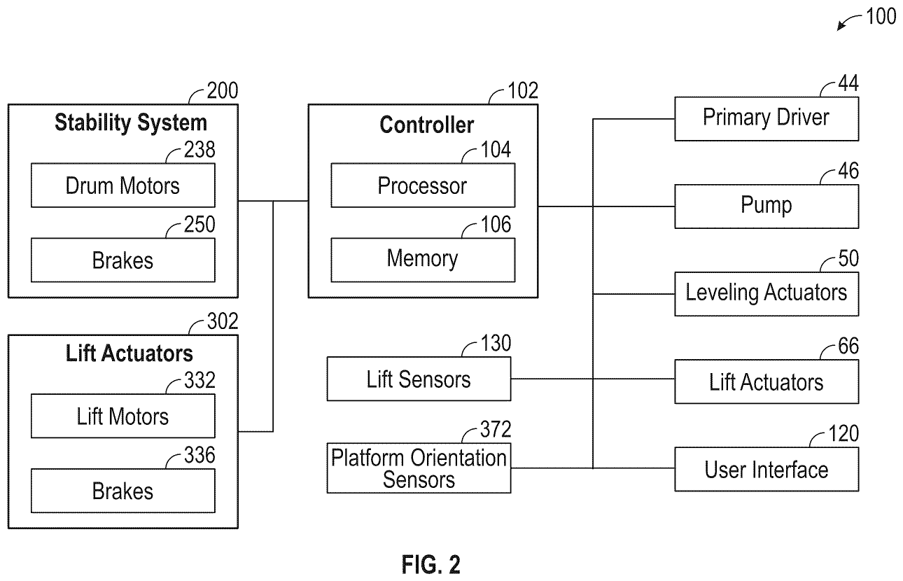

Referring to FIG. 2, the scissor lift 10 includes a control system 100 configured to control the operation of the scissor lift 10. The control system 100 includes a controller 102 including a processor 104 and a memory 106. The processor 104 may issue commands to and process information from other components. The processor 104 may be implemented as a specific purpose processor, an application specific integrated circuit (ASIC), one or more field programmable gate arrays (FPGAs), a group of processing components, or other suitable electronic processing components. The memory 106 may include one or more devices (e.g., RAM, ROM, flash memory, hard disk storage) for storing data and computer code for completing and facilitating the various user or client processes, layers, and modules described in the present disclosure. The memory 106 may be or include volatile memory or non-volatile memory and may include database components, object code components, script components, or any other type of information structure for supporting the various activities and information structures of the inventive concepts disclosed herein. The memory 106 may be communicably connected to the processor 104 and include computer code or instruction modules for executing one or more processes described herein.

The controller 102 may control the operation of the scissor lift 10 including the primary driver 44, the pump 46, the leveling actuators 50, and the lift actuators 66. In some embodiments, the controller 102 interfaces with valves that control the flow of hydraulic fluid to the various hydraulically-powered components of the scissor lift 10. In some embodiments, the controller 102 controls an operating speed (e.g., a throttle, an engine speed, etc.) of the primary driver 44.

The control system 100 further includes an input and/or output device or operator interface, shown as user interface 120. The user interface 120 may be configured to provide information to and receive information (e.g., commands) from an operator. By way of example, the user interface 120 may include screens, buttons, switches, joysticks, or other types of interface devices. The user interface 120 may be positioned on the platform 16. Additionally or alternatively, the user interface 120 may be included as part of a user device (e.g., a smartphone, a table, a laptop computer, a desktop computer, etc.).

The control system 100 further includes one or more transducers or sensors, shown as lift sensors 130. The lift sensors 130 are configured to provide sensor data indicating a current extended length (e.g., a current height) of the lift assembly 14. By way of example, the lift sensors 130 may include linear potentiometers that measure a current extended length of a lift actuator 66. By monitoring the sensor data from the lift sensors 130, the controller 102 may determine whether the lift assembly 14 is raising the platform 16, lowering the platform 16, or holding the platform 16 stationary.

### Stability System

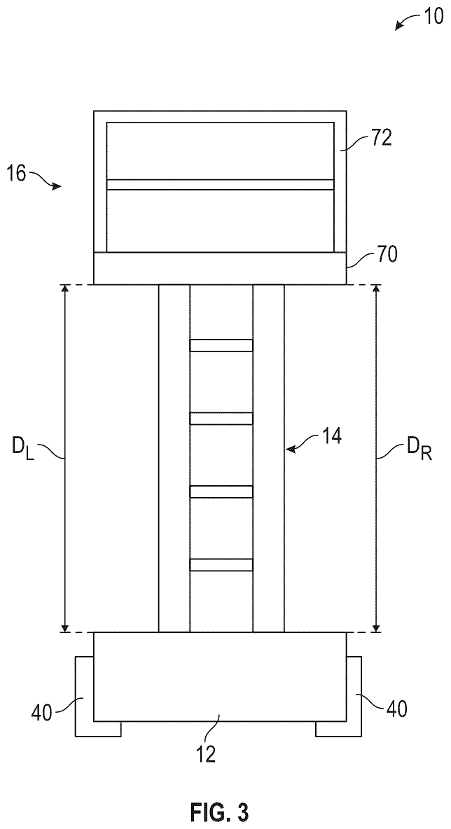

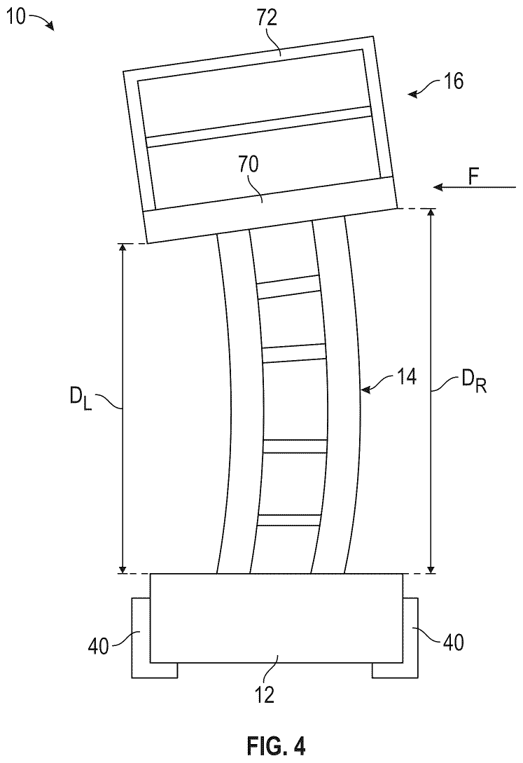

Referring to FIGS. 3 and 4, the scissor lift 10 is shown in a raised configuration, in which the lift assembly 14 has raised the platform 16 above the frame assembly 12. As shown in FIG. 3, when the platform 16 is exposed to minimal external loadings, the lift assembly 14 may extend straight upward between the frame assembly 12 and the platform 16. Accordingly, the platform 16 may be substantially laterally centered relative to the frame assembly 12.

During operation, the scissor lift 10 may be exposed to various forces. As shown in FIG. 4, the platform 16 may be exposed to a laterally-oriented force, shown as lateral force F. By way of example, the lateral force F may be caused by wind blowing against a side of the scissor lift 10. By way of another example, the lateral force F may be caused by the tractive assemblies 40 propelling the scissor lift 10 (e.g., when turning). By way of another example, the lateral force F may be caused by the movement of an operator supported atop the platform 16.

The lateral force F may be oriented such that the lateral force F attempts to move the platform 16 laterally (e.g., parallel to the lateral axis 30). This lateral force F may be opposed and counteracted by the lift assembly 14. However, the lift assembly 14 may experience bending or deflection due to the lateral force F. By way of example, the inner members 62 and/or the outer members 64 may bend in response to the lateral force F. By way of another example, the lateral force F may cause the joints between components of the lift assembly 14 to shift (e.g., due to space between the components of the joints, such as a gap around a pin). As shown in FIG. 4, this bending of the lift assembly 14 may cause the platform 16 to shift laterally relative to the frame assembly 12.

The lateral swaying of the platform 16 may be felt by an operator positioned atop the platform 16. The lateral swaying may be undesirable, as it may cause an operator to feel unsteady and less securely supported by the scissor lift 10. Additionally, the lateral swaying may make it difficult for the operator to perform certain tasks. By way of example, it may be difficult to install a component on a ceiling or wall of a room when the platform 16 sways relative to the ceiling or wall (e.g., requiring the operator to compensate to hold a tool in a steady position while the operator moves).

As shown in FIGS. 3 and 4, the left and right sides of the platform 16 are each offset from the frame assembly 12. Specifically, the left side of the platform 16 is offset a distance D_{L} from the frame assembly 12, and the right side of the platform 16 is offset a distance D_{R} from the frame assembly 12. In the configuration of FIG. 3 where the platform 16 is exposed to minimal external loadings, the distance D_{R} and the distance D_{L} are substantially equal to one another. In the configuration of FIG. 4, the lateral force F is applied to the right side of the platform 16. The reaction of the lift assembly 14 to the lateral force F causes the platform 16 to deflect (e.g., rotate, translate). This deflection increases the distance D_{R}. The distance D_{L} may increase or decrease.

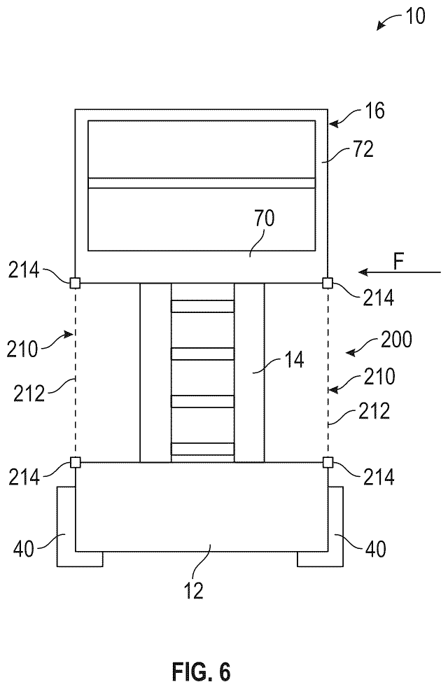

Referring to FIGS. 2, 5, and 6, the scissor lift 10 is equipped with a stability cable system, a counter tension system, or a stability system, shown as stability system 200. As shown in FIG. 6, the stability system 200 includes one or more tensile or stability assemblies, shown as cable assemblies 210, that extend between the platform 16 and the frame assembly 12. The stability system 200 may include multiple cable assemblies 210 positioned at various locations around the periphery (e.g., along the sides, the ends, etc.) of the scissor lift 10. The cable assemblies 210 may apply a tensile force to resist the deflection of the platform 16 relative to the frame assembly 12 that would otherwise cause undesirable swaying of the platform 16. The cable assemblies 210 may vary in length to accommodate the intended raising and lowering the platform 16 during normal operation (e.g., movement caused by the lift actuators 66).

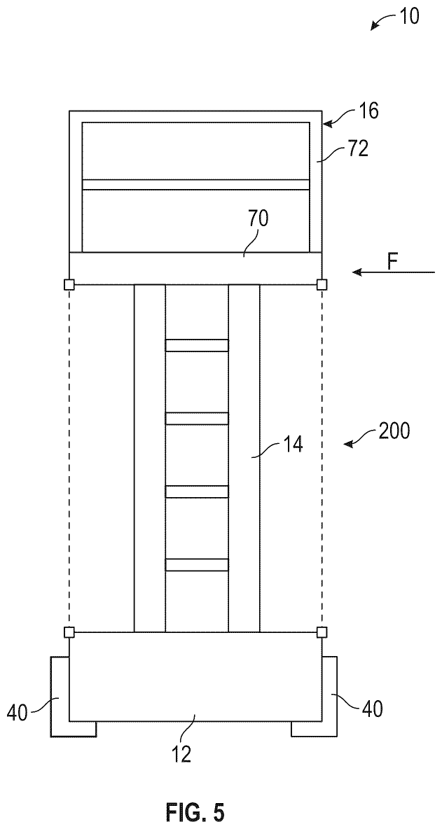

As shown in FIG. 6, each cable assembly 210 includes a tensile member (e.g., a cable, a rope, a line, a wire, a guy wire, a chain, a stay, etc.), shown as stability cable 212, that extends between the frame assembly 12 and the platform 16. The stability cable 212 is coupled to the frame assembly 12 by one or more first interfaces, shown as cable couplers 214, and coupled to the platform 16 by one or more second cable couplers 214. As the lift assembly 14 raises the platform 16 (e.g., transitioning from the configuration of FIG. 6 to the configuration of FIG. 5), one or more of the cable couplers 214 may pay out (e.g., dispense) cable to increase a working length of the stability cable 212 and permit uninhibited extension of the lift assembly 14. When the lift assembly 14 lowers the platform 16 (e.g., transitioning from the configuration of FIG. 5 to the configuration of FIG. 6), one or more of the cable couplers 214 may retract or draw in cable to decrease a working length of the stability cable 212 and prevent the stability cable 212 from going slack (e.g., keep the stability cable 212 taut).

Referring to FIG. 4-6, when the lift actuators 66 are not extending or retracting, the cable couplers 214 may keep the working length of the stability cables 212 constant. As discussed with respect to FIG. 4, the lateral force F causes swaying of the platform 16 by varying the distance DR or the distance DL. By maintaining the working length of the stability cables 212, the stability cables 212 apply a downward tensile force on the platform 16 and an upward tensile force on the platform 16. The forces of the stability cables 212 oppose the change in the distance DR and the distance DL, maintaining the current position of the platform 16 and reducing or eliminating swaying of the platform 16.

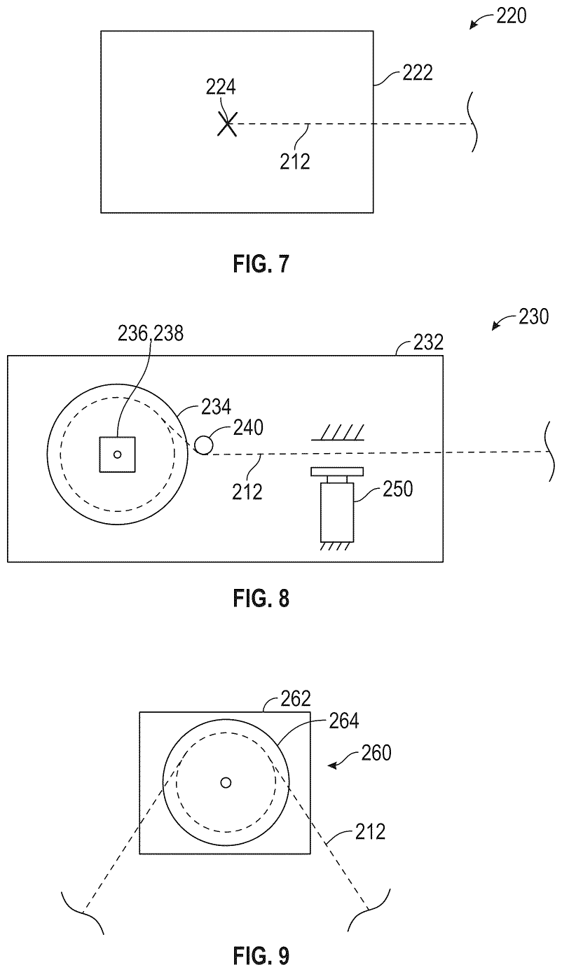

Referring to FIG. 7-9, examples of the cable couplers 214 are shown according to various embodiments. The cable couplers 214 of FIG. 7-9 may represent any of the cable couplers 214 shown and described herein. FIG. 7 illustrates a fixed cable coupler 220, FIG. 8 illustrates a variable cable coupler 230, and FIG. 9 illustrates a pulley cable coupler 260. Each cable assembly 210 may include one or more of the fixed cable couplers 220, the variable cable couplers 230, and/or the pulley cable couplers 260.

Referring to FIG. 7, a cable interface or cable coupler is shown as fixed cable coupler 220, according to an exemplary embodiment. The fixed cable coupler 220 is an example of a cable coupler 214. The fixed cable coupler 220 includes a frame, base, or housing, shown as housing 222. The housing 222 may be fixedly coupled to the frame assembly 12 and/or the platform 16. The fixed cable coupler 220 includes a fixed attachment point, shown as fixture 224. The fixture 224 fixedly couples an end of the stability cable 212 to the housing 222. Accordingly, the fixture 224 may fixedly couple the end of the stability cable 212 to the platform 16 or to the frame assembly 12.

Referring to FIG. 8, a cable interface or cable coupler is shown as variable cable coupler 230, according to an exemplary embodiment. The variable cable coupler 230 is an example of a cable coupler 214. The variable cable coupler 230 includes a frame, base, or housing, shown as housing 232. The housing 232 may be fixedly coupled to the frame assembly 12 and/or the platform 16.

As shown in FIG. 8, the variable cable coupler 230 includes a pulley or drum, shown as cable drum 234, rotatably coupled to the housing 232. An end portion of the stability cable 212 is wound around the cable drum 234 (e.g., a partial revolution around the cable drum 234, a full revolution around the cable drum 234, multiple revolutions around the cable drum 234, etc.).

When the cable drum 234 rotates in a first direction (e.g., clockwise as shown in FIG. 8), a portion of the stability cable 212 that was previously wound around the cable drum 234 is unwound and dispensed from the housing 232, increasing the working length of the stability cable 212. When the cable drum 234 rotates in a second direction (e.g., counterclockwise as shown in FIG. 8), a portion of the stability cable 212 is drawn into the housing 232 and wound around the cable drum 234, reducing the working length of the stability cable 212.

As shown in FIG. 8, the variable cable coupler 230 includes a biasing element, shown as torsion spring 236. By way of example, the torsion spring 236 may be a coil spring. The torsion spring 236 is coupled to the cable drum 234 and the housing 232 and applies a biasing torque onto the cable drum 234. This biasing torque (e.g., driving the cable drum 234 counterclockwise) may cause the cable drum 234 to impart a tensile biasing force onto the stability cable 212. Accordingly, the torsion spring 236 may cause the stability cable 212 to be retracted into the housing 232 and wound around the cable drum 234 when the tension on the stability cable 212 is less than the biasing force from the torsion spring 236. Accordingly, the torsion spring 236 may maintain a desired tension on the stability cable 212, ensuring that the stability cable 212 remains taut as the platform 16 is lowered.

As shown in FIG. 8, the variable cable coupler 230 further includes an actuator (e.g., an electric motor), shown as drum motor 238. As shown in FIG. 2, the drum motor 238 is operatively coupled to the controller 102 such that the controller 102 controls operation of the drum motor 238. The drum motor 238 is coupled to the housing 232 and the cable drum 234. The drum motor 238 may apply a torque on the cable drum 234 to drive rotation of the cable drum 234. By way of example, the drum motor 238 may apply a torque to cause the cable drum 234 to retract the stability cable 212. The drum motor 238 may constantly apply the torque onto the stability cable 212 to simulate the biasing torque of the torsion spring 236. In some embodiments, either the drum motor 238 or the torsion spring 236 is omitted.

As shown in FIG. 8, the variable cable coupler 230 includes one or more redirecting elements, guides, pulleys, or idlers, shown as idler pulley 240. The idler pulley 240 is positioned to engage the stability cable 212 and redirect a path of the stability cable 212. In some embodiments, the idler pulley 240 is rotatable to minimize resistance to movement of the stability cable 212 due to friction.

As shown in FIG. 8, the variable cable coupler 230 further includes a selective fixture, friction element, or clamp, shown as brake 250. The brake 250 is coupled to the housing 232 and positioned along the path of the stability cable 212. In some embodiments, the brake 250 is positioned between the cable drum 234 and a location where the stability cable 212 exits the housing 232. The brake 250 is configured to selectively resist movement of the stability cable 212 when engaged. By way of example, when engaged, the brake 250 may force a frictional braking element (e.g., a brake pad) into engagement with the stability cable 212. When disengaged, the brake 250 may move the braking element out of engagement with the stability cable 212. By way of another example, when engaged, the brake 250 may force a frictional braking element into engagement with the cable drum 234 to resist (e.g., prevent) the stability cable 212 from being dispensed. When disengaged, the brake 250 may move the braking element out of engagement with the cable drum 234. Accordingly, when engaged, the brake 250 may prevent the working length of the stability cable 212 from increasing. By maintaining the working length of the stability cable 212 at a constant length, the brake 250 may resist or prevent swaying of the platform 16.

Referring to FIG. 9, a cable interface or cable coupler is shown as pulley cable coupler 260, according to an exemplary embodiment. The pulley cable coupler 260 is an example of a cable coupler 214. The pulley cable coupler 260 includes a frame, base, or housing, shown as housing 262. The housing 262 may be fixedly coupled to the frame assembly 12 and/or the platform 16. The pulley cable coupler 260 further includes a redirecting element, guide, pulley, or idler, shown as guide pulley 264, rotatably coupled to the housing 262. The stability cable 212 enters the housing 262, engages and is redirected by the guide pulley 264, and exits the housing 262.

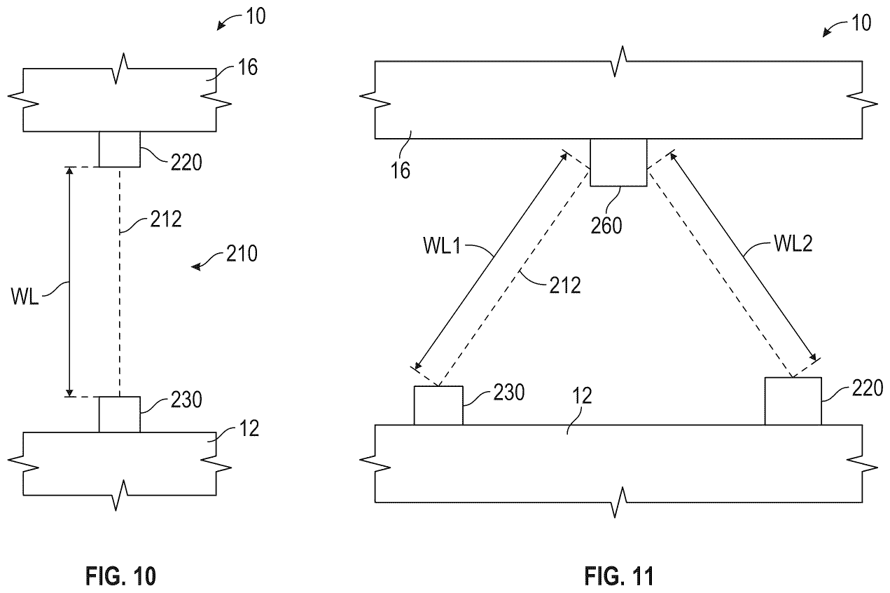

Referring to FIG. 10, a configuration of a cable assembly 210 is shown, according to an exemplary embodiment. The cable assembly 210 includes a variable cable coupler 230 fixedly coupled to the frame assembly 12 and a fixed cable coupler 220 coupled to platform 16. A stability cable 212 extends directly from the fixed cable coupler 220 to the variable cable coupler 230. As shown, a working length WL of the stability cable 212 is measured between the fixed cable coupler 220 and the variable cable coupler 230. The variable cable coupler 230 may dispense or retract the stability cable 212 to vary the working length WL of the stability cable 212.

Referring to FIG. 11, another configuration of a cable assembly 210 is shown, according to another exemplary embodiment. The cable assembly 210 includes a variable cable coupler 230 fixedly coupled to the frame assembly 12, a pulley cable coupler 260 fixedly coupled to the platform 16, and a fixed cable coupler 220 fixedly coupled to the frame assembly 12. A stability cable 212 extends from the variable cable coupler 230, through the pulley cable coupler 260, to the fixed cable coupler 220. As shown, the working length of the stability cable 212 includes a first working length portion WL1 that is measured between the variable cable coupler 230 and the pulley cable coupler 260, and a second working length portion WL2 that is measured between the pulley cable coupler 260 and the fixed cable coupler 220. The variable cable coupler 230 may dispense or retract the stability cable 212 to vary the first working length portion WL1 and the second working length portion WL2 of the stability cable 212. In some embodiments, the fixed cable coupler 220 is replaced with a second variable cable coupler 230 such that the cable assembly 210 includes two variable cable couples 230 with a pulley cable coupler 260 therebetween.

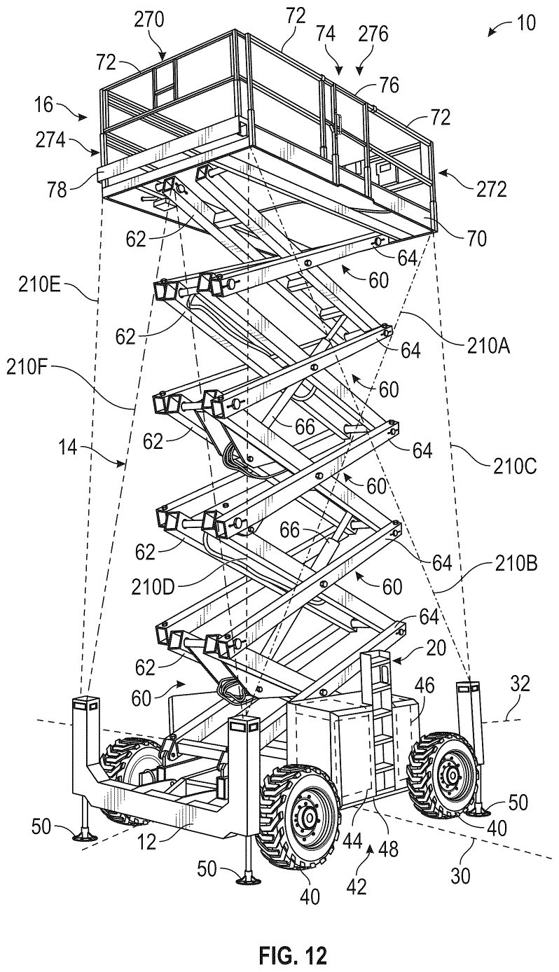

As shown in FIG. 12, the scissor lift 10 is shown including the cable assemblies 210 in various locations along a perimeter of the 10. The scissor lift 10 has a front side 270, a rear side 272, a left side 274, and a right side 276. The front side 270 and the rear side 272 extend laterally (i.e., parallel to the lateral axis 30). The left side 274 and the right side 276 extend longitudinally (i.e., parallel to the longitudinal axis 32).

As shown in FIG. 12, the scissor lift 10 includes cable assemblies 210A, 210B, 210C, 210D, 210E, and 210F. The cable assemblies 210A, 210B, 210C, 210D, 210E, and 210F are positioned along the front side 270 and the right side 276. In some embodiments, the stability system 200 is symmetrically arranged about the lateral axis 30 and the longitudinal axis 32, such that a set of cable assemblies 210 are arranged similarly along the rear side 272 and the left side 274. In other embodiments, one or more of the cable assemblies 210 are omitted, or the cable assemblies 210 are otherwise arranged.

As shown in FIG. 12, the cable assembly 210A extends along the right side 276. The cable assembly 210A is coupled to the platform 16 at the rear side 272 and coupled to the frame assembly 12 at the front side 270. The cable assembly 210A may have a similar arrangement to the cable assembly 210 of FIG. 10.

As shown in FIG. 12, the cable assembly 210B extends along the right side 276. The cable assembly 210B is coupled to the platform 16 at the front side 270 and coupled to the frame assembly 12 at the rear side 272. The cable assembly 210B may have a similar arrangement to the cable assembly 210 of FIG. 10.

As shown in FIG. 12, the cable assembly 210C extends substantially vertically near the intersection of the right side 276 and the rear side 272. The cable assembly 210C is coupled to the platform 16 and the frame assembly 12 at this intersection. The cable assembly 210C may have a similar arrangement to the cable assembly 210 of FIG. 10.

As shown in FIG. 12, the cable assembly 210D extends substantially vertically near the intersection of the right side 276 and the front side 270. The cable assembly 210D is coupled to the platform 16 and the frame assembly 12 at this intersection. The cable assembly 210D may have a similar arrangement to the cable assembly 210 of FIG. 10.

As shown in FIG. 12, the cable assembly 210E extends substantially vertically near the intersection of the left side 274 and the front side 270. The cable assembly 210E is coupled to the platform 16 and the frame assembly 12 at this intersection. The cable assembly 210E may have a similar arrangement to the cable assembly 210 of FIG. 10.

As shown in FIG. 12, the cable assembly 210F extends along the front side 270. The cable assembly 210F has a first end coupled to the frame assembly 12 near the left side 274, a middle portion coupled to the platform 16 near the middle of the front side 270, and a second end coupled to the frame assembly 12 near the right side 276. The cable assembly 210F may have a similar arrangement to the cable assembly 210 of FIG. 11.

Referring to FIGS. 2, 5, and 6, the controller 102 may control operation of the stability system 200. Throughout operation of the scissor lift 10, the controller 102 may monitor various signals to determine a desired or current status (e.g., state) of the lift assembly 14 (e.g., lowering, raising, or holding position). In some embodiments, the controller 102 monitors commands from an operator to determine the desired status. By way of example, the user interface 120 may include a joystick or other interface through which a user controls the lift assembly 14. Pressing upward on the joystick may indicate a command for the lift assembly 14 to raise the platform 16. Pressing downward on the joystick may indicate a command for the lift assembly 14 to lower the platform 16. Allowing the joystick to remain in a central position (e.g., by letting go of the joystick) may indicate a command for the lift assembly 14 to hold position or remain stationary.

In some embodiments, the controller 102 monitors the current or most recent commands provided by the controller 102 to the lift actuator 66 to determine the current status of the lift assembly 14. The controller 102 may control the movement of the lift actuator 66. Accordingly, by monitoring the current or most recent commands to the lift actuator 66, the controller 102 may determine whether the lift assembly 14 is raising the platform 16, lowering the platform 16, or holding the platform 16 stationary.

In some embodiments, the controller 102 monitors sensor data from the lift sensors 130 to determine the current status of the lift assembly 14. The lift sensors 130 provide sensor data indicating a current extended length (e.g., a current height) of the lift assembly 14. Using the sensor data from the lift sensors 130, the controller 102 may determine a rate and direction of change of the current extended length of the lift assembly 14. Using this rate and direction of change, the controller 102 may determine whether the lift assembly 14 is raising the platform 16, lowering the platform 16, or holding the platform 16 stationary.

In response to an indication or determination that the lift assembly 14 is raising the platform 16 (e.g., moving from the configuration of FIG. 6 to the configuration of FIG. 5), the controller 102 may disengage the brakes 250. By disengaging the brakes 250, the working lengths of the stability cables 212 may be permitted to change. The lifting force of the lift assembly 14 may overcome the biasing forces of the torsion springs 236 and/or the drum motors 238, causing the cable drums 234 to pay out cable and increase the working length of the stability cables 212. In some embodiments, the controller 102 controls the drum motors 238 to drive in a dispensing direction (e.g., clockwise as shown in FIG. 8) to cause the cable drums 234 to pay out the cable. Accordingly, the stability system 200 permits the lift assembly 14 to extend.

In response to an indication or determination that the lift assembly 14 is lowering the platform 16 (e.g., moving from the configuration of FIG. 5 to the configuration of FIG. 6), the controller 102 may disengage the brakes 250. By disengaging the brakes 250, the working lengths of the stability cables 212 may be permitted to change. As the platform 16 moves downward, a shorter working length of the stability cables 212 is required to maintain a constant tension on the stability cables 212. If the stability cable 212 were permitted to go slack, the stability cables 212 could tangle with other components of the scissor lift 10. The torsion springs 236 and/or the drum motors 238 may apply a biasing torque onto the cable drums 234, causing the cable drums 234 to retract the cable and decrease the working length of the stability cables 212.

In response to an indication or determination that the lift assembly 14 is holding the platform 16 stationary, the controller 102 may engage the brakes 250. The brakes 250 may fix the working lengths of the stability cables 212 until the brakes 250 are later disengaged. By fixing the working lengths of the stability cables 212, the tensile forces of the stability cables 212 prevent the platform 16 from moving away from the frame assembly 12. As shown in FIG. 4, swaying of the platform 16 causes the distance between the platform 16 and the lift assembly 14 (e.g., the distance DR) to increase. This increase is resisted (e.g., prevented) by the stability cables 212, such that the cable assemblies 210 resist (e.g., prevent) swaying of the platform 16. By placing cable assemblies 210 at various positions along the perimeter of the scissor lift 10, the stability system 200 may be resistant to swaying caused by forces exerted in various directions (e.g., left to right, right to left, front to back, back to front, diagonally, etc.). In some embodiments, the load resistance of the lift assembly 14 is increased (e.g., by increasing the thickness of the inner members 62 and the outer members 64) to accommodate both the load supported by the platform 16 and the downward forces of the stability cables 212.

### Lift Actuator With Interlocking Bands

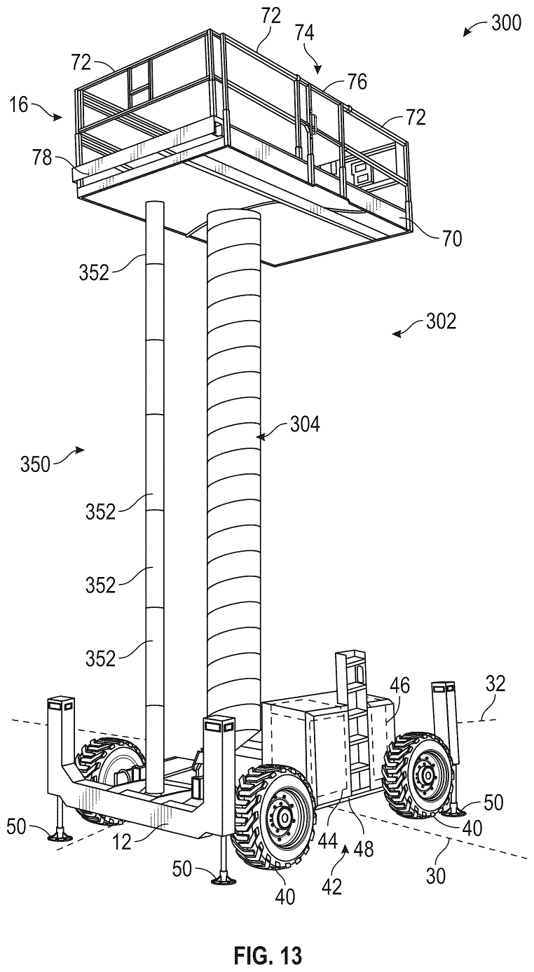

Referring to FIG. 13, a vertical lift is shown as lift device 300, according to an exemplary embodiment. The lift device 300 represents an alternative embodiment of the scissor lift 10 (e.g., a scissor-less and boom-less vertical aerial work platform or lift device). The lift device 300 of FIG. 13 may be substantially similar to the scissor lift 10 of FIG. 1 except as otherwise specified herein. The lift device 300 may utilize the control system of FIG. 2.

As shown in FIG. 13, the lift device 300 omits the lift assembly 14. Instead, the lift device 300 includes a scissor-less and boom-less lift assembly, shown as lift assembly 302, that raises and lowers the platform 16. The lift assembly 302 includes a linear actuator, self-assembling actuator, or support column actuator, shown as lift actuator 304. The lift actuator 304 has an upper end portion coupled to the platform 16 and a lower end portion coupled to the frame assembly 14. The lift actuator 304 may support the platform 16, limiting longitudinal and lateral movement of the platform 16 relative to the frame assembly 12. The term “scissor-less” lift assembly as used herein means a lift assembly that does not include the scissor layers 60. The term “boom-less” lift assembly as used herein means a lift assembly that does not include (a) an articulating boom assembly having one or more pivotable booms sections or arms or (b) a telescoping/translating boom assembly having multiple boom sections or members that translationally or slidably coupled to each other.

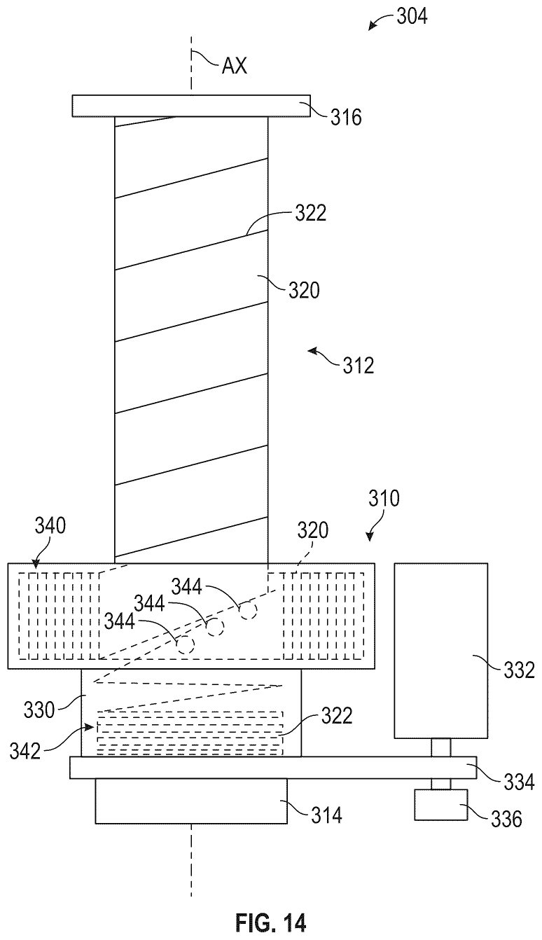

Referring to FIG. 14-19, the lift actuator 304 is shown according to an exemplary embodiment. The lift actuator 304 includes a first portion, active portion, or storage portion, shown as control portion 310, and a second portion or controlled portion, shown as support column 312. The support column 312 extends upward from the control portion 310 toward the platform 16. The control portion 310 includes a first interface or stationary portion, shown as frame interface 314. The frame interface 314 is fixedly coupled to the frame assembly 12. The support column 312 further includes a second interface or stationary portion, shown as platform interface 316. The platform interface 316 is fixedly coupled to the platform 16. In operation, the control portion 310 varies a length of the support column 312 to raise or lower the platform 16.

The support column 312 includes a pair of interlocking bands, panels, plates, members, straps, hoops, or strips, shown as upright band 320 and locking band 322. The upright band 320 and the locking band 322 extend helically or in a spiral pattern centered about a vertical axis, shown as central axis AX. The upright band 320 extends substantially vertically, and the locking band 322 extends substantially horizontally. The locking band 322 extends between adjacent wraps of the upright band 320 and engages the wraps to fixedly couple the wraps of the upright band 320 to one another. Together, the upright band 320 and the locking band 322 form a hollow column having an annular profile that acts as a support column 312. The support column 312 is a self-supporting structure that is capable of resisting vertical, lateral, and longitudinal loads. Accordingly, the support column 312 may be capable of supporting the platform 16 without the use of other systems (e.g., without the scissor layers 60 of the lift assembly 14).

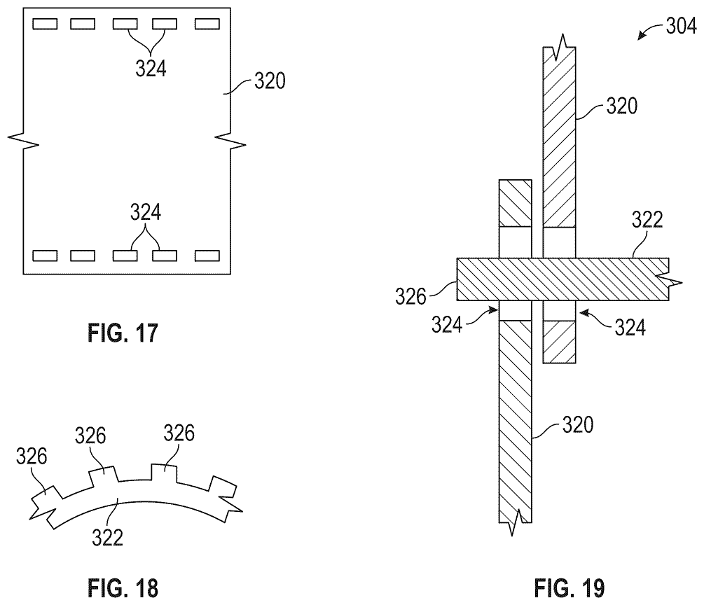

Referring to FIG. 17-19, the upright band 320 and the locking band 322 are shown. The upright band 320 defines a series of apertures, shown as finger passages 324. The finger passages 324 extend radially through the upright band 320 relative to the central axis AX. A first series of the finger passages 324 are arranged or positioned at regular intervals along an upper edge of the upright band 320. A second series of the finger passages 324 are arranged or positioned at regular intervals along a lower edge of the upright band 320.

The locking band 322 includes a series of protrusions, shown as locking fingers 326, arranged at regular intervals along an outer edge of the locking band 322. A trough or recess is defined between each adjacent locking finger 326. The locking fingers 326 extend radially outward relative to the central axis AX.

As shown in FIG. 19, adjacent wraps of the upright band 320 overlap one another. Specifically, the upper edge of the outer wrap overlaps the lower edge of the inner wrap. The finger passages 324 positioned along the upper edge of the outer wrap align with the finger passages 324 positioned along the lower edge of the inner wrap. The locking fingers 326 extend radially outward through the finger passages 324. Accordingly, the locking fingers 326 act in a vertical shear configuration to fixedly couple the adjacent wraps of the upright band 320 to one another.

Referring to FIG. 14-16, the control portion 310 includes a support or housing, shown as storage frame 330. The storage frame 330 is rotatably coupled to the frame interface 314. The storage frame 330 is configured to rotate about the central axis AX relative to the frame interface 314. An actuator or driver (e.g., an electric motor, a hydraulic motor, a power take off from an internal combustion engine, etc.), shown as lift motor 332, is coupled to the frame assembly 12. An output shaft of the lift motor 332 is coupled to the storage frame 330 by a power transmission member (e.g., a chain, a timing belt, etc.), shown as chain 334. In some embodiments, the output shaft and the storage frame 330 each include an interface member, such as a pulley or sprocket, that engages the chain 334. The chain 334 transfers rotational mechanical energy from the lift motor 332 to the storage frame 330. Accordingly, the lift motor 332 may control rotation of the storage frame 330. As shown in FIG. 2, the lift motor 332 is operatively coupled to the controller 102, such that the controller 102 may control operation of the lift motor 332. In some embodiments, a lift sensor 130 indicates the current extended length of the lift actuator 304 by measuring the angular position of the output shaft of the lift motor 332.

As shown in FIGS. 2 and 14, the control portion 310 further includes a brake or holding device, shown as brake 336. The brake 336 may be coupled to the output shaft of the lift motor 332 and/or the storage frame 330. The brake 336 is operatively coupled to and controlled by the controller 102. The brake 336 may be selectively engaged to limit (e.g., prevent) rotation of the storage frame 330, holding the current vertical position of the platform 16.

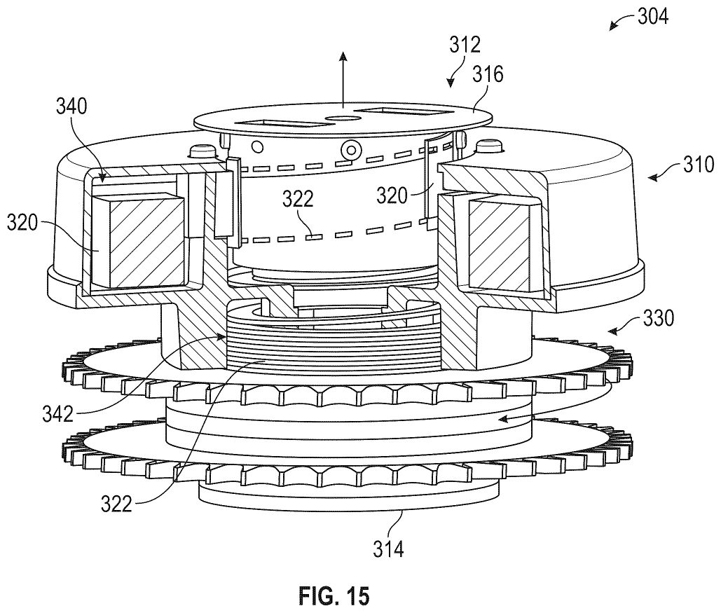

As shown in FIG. 14-16, the storage frame 330 includes a pair of storage areas, storage volumes, or storage trays, shown as upright band storage tray 340 and locking band storage tray 342. The upright band storage tray 340 and the band storage tray 342 are substantially centered about the central axis AX. As shown in FIG. 15, the upright band storage tray 340 and the band storage tray 342 are both annular volumes. The upright band storage tray 340 is positioned above the band storage tray 342. The upright band storage tray 340 extends farther outward radially than the band storage tray 342.

The upright band storage tray 340 contains a first portion (e.g., a storage portion, a stored portion) of the upright band 320. The storage portion of the upright band 320 is continuous with a deployed portion of the upright band 320 included in the support column 312. As the support column 312 is deployed (i.e., increases in length), the upright band 320 is dispensed from the upright band storage tray 340 into the support column 312. The storage portion of the upright band 320 includes a series of concentric wraps arranged at a common position along the central axis AX (e.g., at a common height).

The locking band storage tray 342 contains a first portion (e.g., a storage portion, a stored portion) of the locking band 322. The storage portion of the locking band 322 is continuous with a deployed portion of the locking band 322 included in the support column 312. As the support column 312 is deployed (i.e., increases in length), the locking band 322 is dispensed from the locking band storage tray 342 into the support column 312. The storage portion of the locking band 322 includes a series of stacked wraps or coils arranged at ascending positions along the central axis AX (e.g., at different heights).

As shown in FIG. 14, the control portion 310 further includes a series of bearing members, roller bearings, bushings, or ball bearings, shown as support bearings 344. The support bearings 344 are each rotatably coupled to the storage frame 330 and positioned within the storage frame 330. The support bearings 344 are arranged in a helical, inclined, or spiral patter on an inner surface of the storage frame 330. The support bearings 344 engage a bottom surface of the locking band 322 to support the support column 312.

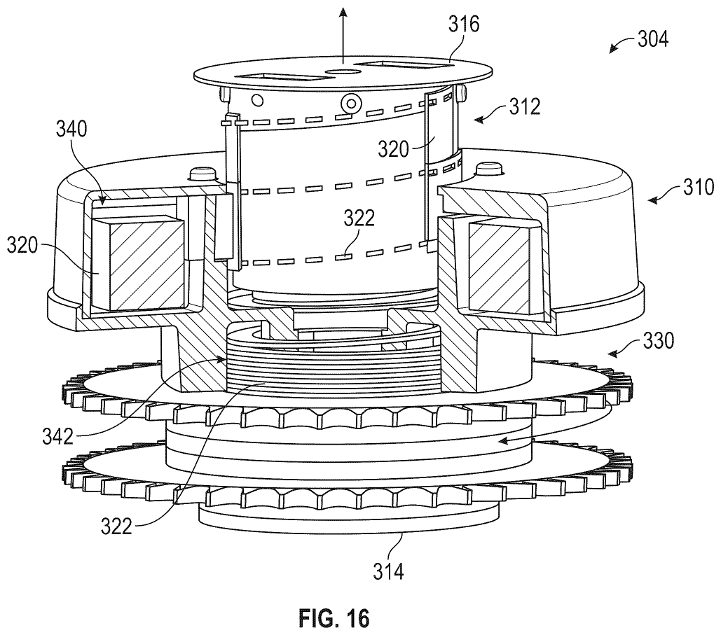

Referring to FIG. 14-16, the lift actuator 304 may be deployed, constructed, or extended to increase the length of the support column 312 and raise the platform 16. Similarly, the lift actuator 304 may be stored, deconstructed, or retracted to decrease the length of the support column 312 and lower the platform 16. FIG. 14 illustrates the lift actuator 304 in an extended configuration. FIG. 15 illustrates the lift actuator 304 in a retracted configuration. FIG. 16 illustrates the lift actuator 304 in a partially extended configuration or partially retracted configuration between the extended configuration of FIG. 14 and the retracted configuration of FIG. 15.

Referring to FIG. 14-19, to extend the lift actuator 304, the storage frame 330 may be rotated relative to the frame interface 314 (e.g., by the lift motor 332) in a first direction (e.g., clockwise). The support column 312 begins with a relatively short length supported at least partially by the support bearings 344. As the storage frame 330 rotates, the support bearings 344 move along the locking band 322, forcing the locking band 322 upward and drawing additional length of the locking band 322 out of the band storage tray 342 and into the support column 312. As shown in FIG. 19, the locking fingers 326 of the locking band 322 are inserted through the finger passages 324 of a first wrap (e.g., an inner wrap) of the upright band 320. As the storage frame 330 rotates, the upright band 320 is pulled out of the upright band storage tray 340 and wrapped around the base of the support column 312. Because the support bearings 344 constantly move the support column 312 upward, the upright band 320 wraps around the support column 312 in a spiral or helical pattern. A second wrap of the upright band 320 wraps around the first wrap, and the locking fingers 326 of the locking band 322 are inserted through the finger passages 324 of the second wrap of the upright band 320. Accordingly, the locking fingers 326 fixedly couple the two wraps of the upright band 320 to one another. The storage frame 330 may continue to be rotated relative to the frame interface 314 to extend the lift actuator 304 until a desired length is reached (e.g., corresponding to a desired height of the platform 16).

Referring still to FIG. 14-19, to retract the lift actuator 304, the storage frame 330 may be rotated relative to the frame interface 314 (e.g., by the lift motor 332) in a second direction (e.g., counterclockwise). The support column 312 begins with a relatively long length supported at least partially by the support bearings 344. As the storage frame 330 rotates, the upright band 320 is pulled outward and into the upright band storage tray 340, freeing the locking band 322 from engagement with the upright band 320. The support bearings 344 move along the locking band 322, permitting the locking band 322 to move downward and retract into the band storage tray 342. The storage frame 330 may continue to be rotated relative to the frame interface 314 to retract the lift actuator 304 until a desired length is reached (e.g., corresponding to a desired height of the platform 16).

The controller 102 may control operation of the lift assembly 302. The controller 102 may receive a command from an operator (e.g., through the user interface 120). If the command indicates that the platform 16 should be raised, the controller 102 may disengage the brake 336 and control the lift motor 332 to extend the lift actuator 304 until a desired length of the lift actuator 304 and a corresponding desired height of the platform 16 is reached. Once in the desired position, the controller 102 may deactivate the lift motor 332 and engage the brake 336 to maintain the current length of the lift actuator 304. If the command indicates that the platform 16 should be lowered, the controller 102 may disengage the brake 336 and control the lift motor 332 to retract the lift actuator 304 until a desired length of the lift actuator 304 and a corresponding desired height of the platform 16 is reached. Once in the desired position, the controller 102 may deactivate the lift motor 332 and engage the brake 336 to maintain the current length of the lift actuator 304.

Referring to FIGS. 13 and 14, the platform interface 316 may be fixedly coupled to the platform 16 and rotatably coupled to the support column 312. By way of example, the platform interface 316 may include a bearing (e.g., a ball bearing, a roller bearing, a slewing bearing, etc.) that rotatably couples the platform 16 and a portion of the platform interface 316 to the support column 312. To extend and retract the support column 312, the support column 312 may be required to rotate about the central axis AX. By rotatably coupling the platform 16 to the support column 312 with the platform interface 316, the orientation of the platform 16 may be permitted to remain stationary while the support column 312 rotates.

As shown in FIG. 13, to ensure that the platform 16 maintains a constant orientation (e.g., does not rotate about the central axis AX relative to the frame assembly 12), the lift assembly 302 includes a clocking assembly or rotation control assembly, shown as telescoping assembly 350. The telescoping assembly 350 includes a series of telescoping sections 352 arranged in a telescoping arrangement. The lowermost of the telescoping sections 352 may be coupled to the frame assembly 12, and the uppermost of the telescoping sections 352 may be coupled to the platform 16. The telescoping sections 352 may slide freely relative to one another to vary the length of the telescoping assembly 350 and accommodate a change in length of the lift actuator 304. However, the telescoping assembly 350 may be offset from the central axis AX to resist rotation of the platform 16 relative to the frame assembly 12.

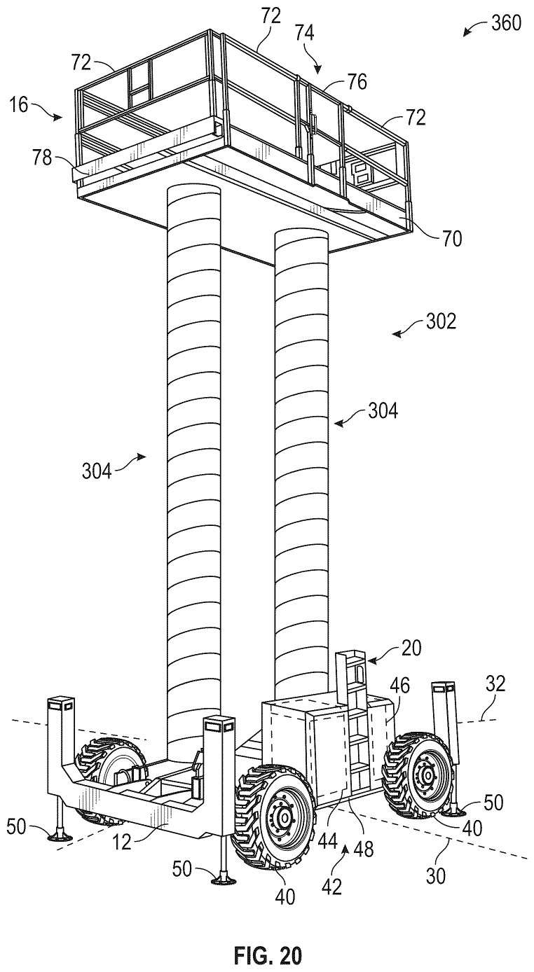

Referring to FIG. 20, a vertical lift is shown as lift device 360, according to an exemplary embodiment. The lift device 360 represents an alternative embodiment of the lift device 300. The lift device 360 of FIG. 20 may be substantially similar to the lift device 300 of FIG. 13 except as otherwise specified herein.

The lift device 360 of FIG. 20 omits the telescoping assembly 350. Instead, the lift device 360 includes two lift actuators 304 that are offset (e.g., longitudinally) from one another. By including two lift actuators 304, the orientation of the platform 16 relative to the frame assembly 12 may be fixed (e.g., because each lift actuator 304 prevents rotation of the platform 16 about the central axis AX of the other lift actuator 304). Accordingly, the second lift actuator 304 may act as a clocking assembly or rotation control assembly, similar to the telescoping assembly 350. In some embodiments, the controller 102 controls the lift motors 332 of the lift actuators 304 to operate simultaneously and at the same speed to ensure that the two lift actuators 304 extend at the same rate (e.g., preventing skewing or tilting of the platform 16). The controller 102 may use feedback from the lift sensors 130 to provide closed-loop control over the length of each lift actuator 304 and assist with relative timing of the lift actuators 304.

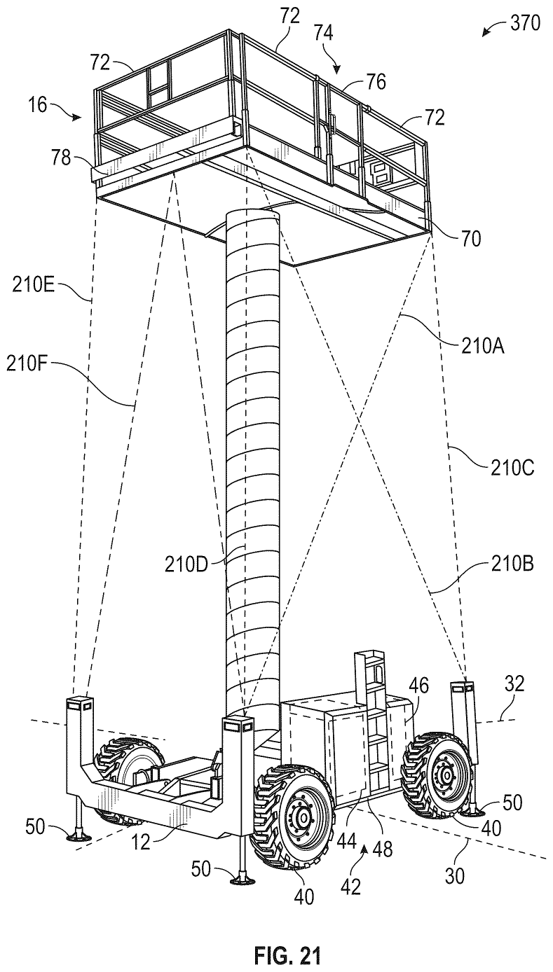

Referring to FIG. 21, a vertical lift is shown as lift device 370, according to an exemplary embodiment. The lift device 370 represents an alternative embodiment of the lift device 300. The lift device 370 of FIG. 21 may be substantially similar to the lift device 300 of FIG. 13 except as otherwise specified herein.

The lift device 370 may incorporate one or more of the cable assemblies 210 of the stability system 200 to fix or maintain the orientation of the platform 16 relative to the frame assembly 12. As shown in FIG. 21, the lift device 370 includes cable assemblies 210A, 210B, 210C, 210D, 210E, and 210F. The cable assemblies 210A, 210B, 210C, 210D, 210E, and 210F are positioned similarly to the cable assemblies 210A, 210B, 210C, 210D, 210E, and 210F of FIG. 12. The structure and function of the cable assemblies 210 of the lift device 370 may be substantially similar to the cable assemblies 210 described with respect to FIG. 5-12, except as otherwise specified herein.

In some embodiments, the controller 102 controls the lengths of cable assemblies 210 to fix or maintain the orientation of the platform 16 relative to the frame assembly 12. If a force is applied to the platform 16 that would cause the platform 16 to rotate out of the desired orientation, the force may be counteracted by a tensile force of a stability cable 212 of a cable assembly 210. The cable assembly 210 may be oriented to apply the tensile force in a desired direction. By way of example and referring to the arrangement of FIG. 21, rotation of the platform 16 in a first direction may opposed by the tensile force of the cable assemblies 210A, 210C, 210D, 210E, and 210F. Rotation of the platform 16 in a second direction may be opposed by the tensile force of the cable assemblies 210B, 210C, 210D, 210E, and 210F. Accordingly, the cable assemblies 210 may act as a clocking assembly or rotation control assembly, similar to the telescoping assembly 350.

As the platform 16 is raised and lowered by the lift actuator 304, the working lengths of each cable assembly 210 required to maintain the orientation of the platform 16 may vary. By way of example, lowering the platform 16 may reduce the required working lengths. By way of another example, raising the platform 16 may increase the required working lengths.

In some embodiments, the controller 102 monitors sensor data from the lift sensors 130 to determine the current status of the platform 16. The lift sensors 130 provide sensor data indicating a current extended length (e.g., a current height) of the lift actuator 304. Using the sensor data from the lift sensors 130, the controller 102 may determine a rate and direction of change of the current extended length of the lift actuator 304. Using this rate and direction of change, the controller 102 may determine whether the lift actuator 304 is raising the platform 16, lowering the platform 16, or holding the platform 16 stationary.

In response to an indication or determination that the lift actuator 304 is raising the platform 16, the controller 102 may disengage the brakes 250. By disengaging the brakes 250, the working lengths of the stability cables 212 may be permitted to change. The controller 102 may controls the drum motors 238 to drive in a dispensing direction (e.g., clockwise as shown in FIG. 8) to cause the cable drums 234 to pay out the cable. Accordingly, the stability system 200 permits the lift actuator 304 to extend.

In response to an indication or determination that the lift actuator 304 is lowering the platform 16, the controller 102 may disengage the brakes 250. By disengaging the brakes 250, the working lengths of the stability cables 212 may be permitted to change. As the platform 16 moves downward, the controller 102 may control the 238 to reduce the working length of the stability cables 212.

In response to an indication or determination that the lift actuator 304 is holding the platform 16 stationary, the controller 102 may engage the brakes 250. The brakes 250 may fix the working lengths of the stability cables 212 until the brakes 250 are later disengaged. By fixing the working lengths of the stability cables 212, the tensile forces of the stability cables 212 prevent the platform 16 from moving away from the frame assembly 12 and maintain the orientation of the platform 16.

As the platform 16 is raised and lowered, it may be advantageous to monitor the lift device 370 to ensure that the cable assemblies 210 are retracted and extended evenly and that the orientation of the platform 16 is maintained. Referring to FIG. 2, the control system 100 may include one or more sensors or transducers, shown as platform orientation sensors 372, that facilitate active (e.g., closed-loop) control over the orientation of the platform 16.

In some embodiments, the platform orientation sensors 372 provide sensor data indicating a rotational orientation of the platform 16 relative to the frame assembly 12. By way of example, the platform orientation sensors 372 may include a potentiometer coupled to the platform 16 and the frame assembly 12 and measuring the rotational orientation of the platform 16 relative to the frame assembly 12 directly. By way of another example, the platform orientation sensors 372 may include a first gyroscopic sensor that measures an orientation (e.g., a compass orientation, an orientation relative to the Earth, an orientation relative to a starting point, etc.) of the frame assembly 12 and a second gyroscopic sensor that measures an orientation of the platform 16, and the controller 102 may compare the sensor data from the first and second sensors to determine the relative orientation. In some embodiments, the platform orientation sensors 372 provide sensor data regarding a component that is coupled to both the frame assembly 12 and the platform 16. By way of example, each cable assembly 210 may include a potentiometer coupled to the cable drum 234 and indicating a current working length of the cable assembly 210.

Referring to FIGS. 2 and 21, the controller 102 may use the sensor data to monitor the orientation of the platform 16. In response to an indication that the platform 16 has exited a desired range of orientations (e.g., a central position±1 degree), the controller 102 may control the drum motors 238 to adjust the working lengths of the cable assemblies 210. By way of example, in response to an indication that the platform 16 has exited the desired range of orientations in a first direction, the controller 102 may (i) disengage the brakes 250, (ii) control the drum motors 238 of a first subset of the cable assemblies 210 to increase the working lengths of the corresponding stability cables 212, (iii) control the drum motors 238 of a second subset of the cable assemblies 210 to decrease the working lengths of the corresponding stability cables 212, and (iv) engage the brakes 250. This may cause the platform 16 to rotate in a second direction opposite the first direction and bring the platform 16 back within the desired range of orientations.

Additionally or alternatively, a relationship between the height of the platform 16 and the working lengths of the cable assemblies 210 may be predetermined and stored in the memory 106. The relationship may be determined mathematically (e.g., based on the geometry of the lift device 370) or experimentally (e.g., by measuring the working lengths at different heights of the platform 16). Using sensor data from the lift sensors 130, the controller 102 may determine the height of the platform 16 and the corresponding desired working lengths of the cable assemblies 210. The controller 102 may control the drum motors 238 to achieve the desired working lengths (e.g., using feedback from the platform orientation sensors 372 indicating the current working lengths of the cable assemblies 210).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the scissor lift 10 as shown in the various exemplary embodiments is illustrative only. Additionally, any element disclosed in one embodiment may be incorporated or utilized with any other embodiment disclosed herein. For example, the cable assembly 210 of the exemplary embodiment shown in at least FIG. 11 may be incorporated in the scissor lift 10 of the exemplary embodiment shown in at least FIG. 5. Although only one example of an element from one embodiment that can be incorporated or utilized in another embodiment has been described above, it should be appreciated that other elements of the various embodiments may be incorporated or utilized with any of the other embodiments disclosed herein.

1. A lift device comprising:
a chassis;
a work platform configured to support an operator; and
a lift assembly having a first end portion coupled to the chassis and a second end portion coupled to the work platform, the lift assembly including:
a first band and a second band each including a deployed portion and a stored portion, the deployed portion of the first band engaging the deployed portion of the second band to form a support column at least partially supporting the work platform;
at least one storage area containing the stored portion of the first band and the stored portion of the second band; and
an actuator configured to drive the stored portion of the first band and the stored portion of the second band to exit the at least one storage area and increase a length of the support column such that the support column raises the work platform.

2. The lift device of claim 1, wherein the second end portion of the lift assembly is rotatably coupled to the work platform.

3. The lift device of claim 2, further comprising a bearing positioned between the work platform and the second end portion of the lift assembly.

4. The lift device of claim 2, further comprising a rotation control assembly coupled to the chassis and the work platform, the rotation control assembly configured to limit rotation of the work platform relative to the chassis.

5. The lift device of claim 4, wherein the rotation control assembly includes a stability cable having a working length, and wherein the working length of the stability cable varies as the lift assembly raises and lowers the work platform.

6. The lift device of claim 4, wherein the lift assembly is a first lift assembly, and wherein the rotation control assembly includes a second lift assembly offset from the first lift assembly.

7. The lift device of claim 4, wherein the rotation control assembly includes a plurality of telescoping sections.

8. An aerial work platform comprising:
a chassis;
a work platform; and
a scissor-less and boom-less lift assembly extending between the chassis and a bottom of the work platform, the scissor-less and boom-less lift assembly configured to vertically raise and lower the work platform relative to the chassis.

9. The aerial work platform of claim 8, wherein the scissor-less and boom-less lift assembly is rotatably coupled to the work platform.

10. The aerial work platform of claim 9, further comprising a bearing positioned between the work platform and the scissor-less and boom-less lift assembly.

11. The aerial work platform of claim 9, further comprising a rotation control assembly coupled to the chassis and the work platform, the rotation control assembly configured to limit rotation of the work platform relative to the chassis.

12. The aerial work platform of claim 11, wherein the rotation control assembly includes a stability cable having a working length, and wherein the working length of the stability cable varies as the scissor-less and boom-less lift assembly raises and lowers the work platform.

13. The aerial work platform of claim 12, wherein the stability cable is a first stability cable and the working length is a first working length, wherein the rotation control assembly includes a second stability cable having a second working length, and wherein the first working length and the second working length are different.

14. The aerial work platform of claim 11, wherein the scissor-less and boom-less lift assembly is a first lift assembly, and wherein the rotation control assembly includes a second lift assembly offset from the first lift assembly.

15. The aerial work platform of claim 11, wherein the rotation control assembly includes a plurality of telescoping sections.

16. The aerial work platform of claim 8, wherein the scissor-less and boom-less lift assembly includes a first band and a second band each including a deployed portion and a stored portion, the deployed portion of the first band engaging the deployed portion of the second band to form a support column at least partially supporting the work platform.

17. The aerial work platform of claim 16, wherein the scissor-less and boom-less lift assembly includes at least one storage area containing the stored portion of the first band and the stored portion of the second band.

18. The aerial work platform of claim 16, wherein the scissor-less and boom-less lift assembly includes an actuator configured to cause the stored portion of the first band to engage with the stored portion of the second band to increase a length of the support column such that the support column raises the work platform.

19. A lift device comprising:
a chassis;
a work platform;
a lift assembly extending between the chassis and a bottom of the work platform, the lift assembly rotatably coupled to the work platform, the lift assembly configured to vertically raise and lower the work platform relative to the chassis; and
a rotation control assembly coupled to the chassis and the work platform, the rotation control assembly configured to limit rotation of the work platform relative to the chassis.

20. The lift device of claim 19, wherein the rotation control assembly includes a stability cable having a working length, and wherein the working length of the stability cable varies as the scissor-less and boom-less lift assembly raises and lowers the work platform.
